(19) United States
(12) Patent Application Publication
(10) Pub. No.: US 2009/0318577 A1
(43) Pub. Date: Dec. 24, 2009

(54) COMPOSITION COMPRISING A PHOSPHATE BINDER AND ITS PREPARATION

(75) Inventor: Anas Haji, Brussels (BE)

Correspondence Address: HOVEY WILLIAMS LLP, 10801 Mastin Blvd., Suite 1000, Overland Park, KS, 66210, US

(73) Assignee: XEXOS LIMITED, Dublin 17 (IE)

(21) Appl. No.: 12/307,247

(22) PCT Filed: Jul. 3, 2007
(86) PCT No.: PCT/BE07/00073

§ 371 Date: May 5, 2009

(30) Foreign Application Priority Data
Jul. 5, 2006 (BE) BE2006/000080

(51) Int. Cl. C08G 18/00; C08K 3/34

(52) U.S. Cl. 521/155; 524/443

(57) ABSTRACT

A binder, a composition, a product and a kit, as well as a process for preparing the binder and composition, are directed to a composition useful as an inorganic phosphate binder, which binder is characterized as having calcium silicate sites which are connected the one with the other by alumina-silica phosphate bonds, and a filer.

### FIELD OF THE INVENTION

The present invention relates to a composition comprising an inorganic binder, most precisely to an inorganic phosphate binder.

### THE PRIOR ART

Inorganic phosphate binder have already been proposed in the past.

For example in a previous patent application WO9903797 in the name of Metal Chemical and Haji Anas, a polymeric matrix is disclosed, said matrix comprising a binder formed by mixing an alkali metal silicate aqueous solution with a powder comprising silico-aluminous reactive raw materials. A polymerization time of more than one hour is however necessary for reaching a sufficient hardening of the matrix.

It has also been proposed in U.S. Pat. No. 6,139,619 to form a binder by mixing a water soluble silicate with a water soluble amorphous inorganic phosphate glass in an aqueous medium. The hardening of the binder requires the removal of water by a heat treatment.

In U.S. Pat. No. 4,375,551, an acid solution is prepared by mixing Al₂O₃.3H₂O with phosphoric acid, said acid solution being then mixed with calcium silicate. The so obtained binder has after hardening poor mechanical strength.

U.S. Pat. No. 4,504,555 discloses an inorganic resin formed by reacting a first liquid component containing a mono aluminum phosphate or a mono magnesium phosphate, with a second liquid component contining magnesium oxide and/or wollastonite and a dispersing agent. Inert filler can be added to the first or second component. The inert filler (particles not participating to the reaction) can be SiO2 particles. The product prepared by this reaction is a resin in which adjacent calcium silicate sites (wollastonite) bound by magnesium/aluminum phosphate bonds, not by alumina silica phosphate bonds.

U.S. Pat. No. 3,179,527 discloses a coating composition formulated by adding silica or lime to an acidic solution of aluminum phosphate. Calcium silicate is then added to the composition. As stated in column 2 of said patent, the effect of added silica depends from the particle size of the silica particles, fine silica particles forming open cracks, while coarser particles do not produce such cracks. The silica particles are therefore not dissolved, otherwise the particle size of the silica particle would have no influence on craks. The silica is therefore used in this patent as filler. The use of silica in a prereacted composition is even not indispensable according to said patent, as it could be replaced by calcium silicate. Silica is therefore not participating in the formation of bond between two adjacent calcium silicate particles. The compositions of this patent have a long shelf stability, meaning that the hardening reaction is a slow process.

Although a good bindability to various support was achieved by using the phosphate binder disclosed in WO 03/031366 and in WO 2005/003056, some bindability problem was still existing on some support.

The present invention has for subject matter an inorganic binder which has excellent binding property, whereby it is even possible to make foamed organic polymer comprising an inorganic binder net.

Advantageously, the binding composition of the invention can be sufficiently hardened within a term of less than 10 minutes and which has excellent mechanical properties. The inorganic binder of the invention is characterized by calcium silicate sites connected the one to the other by alumina-silica phosphate bonds.

### DESCRIPTION OF THE INVENTION

### The Binder

The inorganic binder of the invention is characterized by calcium silicate sites which are connected the one with the other by alumina-silica phosphate bonds and by the presence of an adhesive resin for enhancing hydraulic cement adhesion.

“Adhesive resin for enhancing hydraulic cement adhesion” means compounds suitable for enhancing the adhesion of portland cement and other hydraulic on various support. Adhesive resin for enhancing hydraulic cement adhesion are available in the market. Such resin are intended to be used as an admixture for portland cement and other hydraulic cement compositions. The adhesive resin for enhancing hydraulic cement is advantageously suitable for improving bond strength to substrates selected from the group consisting of concrete, masonry, wood and insulating foams. Preferably, the adhesive resin for enhancing hydraulic cement is selected among adhesive resin suitable for improving the flexural and tensile strengths of hydraulic cement concrete.

The adhesive resin is preferably selected so that the abrasion resistance of the hydraulic cement is improved.

A test for determining preferred adhesive resin to be used in the binder of the invention is disclosed here after.

As testing cement, 100 parts of Portland cement, 250 parts sand, 1 part defoamer, 1 part cellulosic, 20 parts of the adhesive resin and 40 parts of water are mixed together.

As control cement, 100 parts of Portland cement, 250 parts sand, 1 part defoamer, 1 part cellulosic and 40 parts of water are mixed together.

The testing cement and the control cement are tested in the model concrete systems.

Testing of hardened mortar are for example the followings:

### Procedure of Testing

The test for both flexural and compressive strength were performed with an INSTRON-1195 testing machine with a maximum capacity at 100 KN.

At least three specimens (advantageously six or more) were tested for each curing of the same series.

The test specimens (length: 160 mm, cross-section: 40 mm×40 mm) were tested in three points bending (120 mm) span and compression (40 mm×40 mm) area. Tests were performed at a speed of 0.5 mm/minute for bending and 1 mm/minute for compression, as required in the Belgian Standard NBN B15-220, NBN EN 196-1 (1991) and British Standard 1881, part 4.

Flexural strength according to NBN EN 196-1 (1991) determines the bending strength by using the following formula:

R_{bf}=(3×P×L)/(2×b×d²)

### Where:

R_{bf}: Bending strength (N/mm²)
P: Maximum applied load (Newton)
L: Span length (mm)
b: average width of specimens (mm)
d: average depth of specimens (mm)

The compressive strength according to NBN EN 196-1 (1991) was determined by using the following formula:

Rc=P/(b×L)

### Where

Rc: compressive strength (N/mm²)
P: maximum applied load (N/mm²)
L: length of specimens (mm)
b: average width of specimens (mm)

For the Young's modulus (E dyn), the modulus of elasticity was calculated according to NBN B 15230 (1976).

Advantageously the bending, compression, tensile strength and modulus of elasticity are calculated at different ages, for example at the following ages: 7 days, 14 days, 28 days, 56 days, 91 days and 182 days.

Preferred adhesive resins are resins which enable, after a curing time of 28 days at 20° C., to improve one or more of the following properties of the testing cement with respect to the control cement (without adhesive resin):
abrasion resistance so as to reduce the % Loss by a factor of at least 2
tensile strength so as to increase the tensile strength by at least 50%
compressive strength so as to increase the compressive strength by at least 10%
flexural strength so as to increase the flexural strength by at least 30%, preferably by at least 50%,
ceramic Tile shear bond so as to increase the ceramic tile shear bond by at least 20%, preferably at least 50%.

Most preferred adhesive resins are resins enabling to improve at least the following properties simultaneously:
tensile strength so as to increase the tensile strength by at least 50%
compressive strength so as to increase the compressive strength by at least 10%
flexural strength so as to increase the flexural strength by at least 30%, preferably by at least 50%.

Most preferred adhesive resins are adhesive resin which can be dispersed, possibly with one or more surfactant in an aqueous medium. When dispersed in an aqueous medium not containing reacting components for making the alumina-silica bonds, the pH of the aqueous dispersion is advantageously comprised between 6 and 8.5, most preferably between 7 and 8, such as 7.5.

Said pH is measured at 25° C. and with a weight solid content of adhesive resin(s) in the aqueous medium of about 50%.

Advantageously, the calcium silicate sites acts as cross-linking sites for the alumina-silica phosphate bonds with a weight ratio Al₂O₃/SiO₂ ranging from 0.3:1 and 10:1.

Preferably, after hardening and drying, the (dry) inorganic binder comprises from 0.01% to 2% by weight of one or more adhesive resins for enhancing hydraulic cement adhesion. When using 4% by weight adhesive resin as taught for portland cement with some commercial adhesive resin, for the preparation of the alumino-silicate phosphate inorganic binder, the inorganic binder had a bad structure and bad mechanical properties.

The weight content of adhesive resin is determined with respect to dry weight of inorganic binder, i.e. after its curing and after a drying at 120° C. for removing all free water.

Most preferably, the adhesive resin is substantially homogeneously dispersed into the binder.

According to an advantageous embodiment, the inorganic binder comprises from 0.05% to 1% by weight of an adhesive resin for enhancing hydraulic cement adhesion.

Advantageously, the adhesive resin for enhancing hydraulic cement adhesion is selected from the group consisting of acrylic latexes, rubber latexes, vinyl acetate copolymers, polyvinyl acetate polymers, polyvinyl acetate copolymers, and mixtures thereof.

Preferably, the binder comprises at least one surfactant, the weight ratio surfactant/adhesive resin for enhancing hydraulic cement adhesion being lower than 0.1.

The surfactant is advantageously a nonionic surfactant. Preferably, the weight ratio surfactant/adhesive resin for enhancing hydraulic cement adhesion being comprised between 0.01 and 0.05.

Advantageously, the calcium silicate sites are calcium meta silicate sites having a substantially acicular nature with a length/diameter ratio from 2/1 to 50/1, advantageously from 3/1 to 20/1.

Preferably, the calcium meta silicate sites has an average length from 10 μm to 10 mm, advantageously from 50 μm to 5 mm.

The calcium silicate sites act preferably as cross-linking sites for alumina-silica phosphate bonds.

According to an embodiment, the alumina-silca phosphate bonds have a weight ratio Al₂O₃/SiO₂ ranging from 0.3:1 and 10:1, advantageously from 0.6:1 and 6:1.

According to an advantageously embodiment, the weight ratio calcium silicate sites/alumina-silica phosphate bonds is comprised between 0.1 and 1.1, advantageously between 0.3 and 0.9, preferably between 0.4 and 0.7.

The binder of the invention is suitable for preparing product having a light weight (such a weight from 70 to 140 kg/m³) or a heavy weight (such as weight of 2,000 kg/m³ or even more). Products of the invention have high mechanical properties, such as compression strength of more than 40N/mm², bending strength of more than 10 N/mm², etc.

The invention relates also to a composition and a product comprising at least a binder according to the invention and at least one filler and/or reinforced material.

### Compositions of the Invention

The compositions of the invention are composition before hardening, after hardening, possibly after an after treatment, such as a drying step, a heating step, etc.

Compositions of the inventions are compositions comprising at least one inorganic binder of the invention, and one or more fillers, inert fillers with the binder.

The composition of the invention comprises preferably at least:
an inorganic binder having calcium silicate sites which are connected the one with the other by alumina-silica phosphate bonds, the calcium silicate sites acting as cross-linking sites for the alumina-silica phosphate bonds with a weight ratio Al₂O₃/SiO₂ ranging from 0.3:1 to 10:1, advantageously from 0.6:1 to 6:1, said inorganic binder comprising from 0.01% to 2% by weight of an adhesive resin for enhancing cement adhesion, and
a filler.

Examples of fillers or reinforced materials which can be mixed with the binder before its preparation, during its preparation, before its hardening or during its hardening are:
waste materials, such as finely divided waste material, for example fuel ashes, fly ashes, buildings waste materials, etc.
flake-like materials such as mica, etc.,
silica sand, silica flour,
coloring agents or materials, such as inorganic coloring agents, pigments, etc.
cellulose and/or protein base fibers, such as natural fibers, flax, chip, straw, hemp, wool fibers, etc.
synthetic fibers, such as organic synthetic fibers, inorganic synthetic fibers, such as polyesters, polypropylene, glass and ceramic fibers, etc.
natural and synthetic organic base waste materials, such as saw dust, rice husk, straw and recycled organic waste,
natural fibers of mineral origin,
natural material, possibly treated (for example heat treated), such as perlite, vermiculite, etc.
etc.
mixtures of one or more of the above fillers.

Specific examples of possible fillers are:
rice husk,
waste recycle cardboard
shredded paper
rice husk/shredded paper composite
rice husk+waste recycle cardboard
pine needle
laminated elements, such as honeycomb board, normal cardboard, etc.
pigments

Additives can be added to the binder before its preparation, during its preparation, before its hardening or during its hardening, such additives are for example:
foaming agents, such as water peroxide, organic peroxide, etc.
viscosity regulating agent, such as superplasticizer, for example octonal® and hydrosol®,
material for improving the impermeability or the water repulsion such as lignosulfonates and silica fume
   etc.

According to an embodiment, substantially all alumina-silica sites of the inorganic binder are bound the one to the other by alumina-silica phosphate bonds.

According to a specific embodiment, the weight ratio calcium silicate site/SiO₂ present in the alumina-silica phosphate bonds of the inorganic binder is greater than 1, advantageously greater than 1.5, such as 2, 3, 4, 5 or even more.

The calcium silicate particles are advantageously calcium meta silicate particles having a substantially acicular nature with a length/diameter ratio from 2/1 to 50/1, advantageously from 3/1 to 20/1.

The calcium meta silicate particles have preferably an average length from 10 μm to 10 mm, advantageously from 50 μm to 5 mm, such as 100 μm, 300 μm, 500 μm, etc.

According to a preferred embodiment, the calcium silicate particles act as cross-linking sites for alumina-silica phosphate bonds. It seems also that the presence of insoluble calcium silicate particles catalyzes the formation of alumina-silica phosphate bonds.

For example, the weight ratio calcium silicate particles/alumina-silica phosphate solution is comprised between 0.1 and 1.1, preferably from 0.3 and 0.9, most preferably between 0.4 and 0.7.

Preferably, the composition comprises at least a silicon containing filler, most preferably silicon containing fibers with a length of less than 1000 μm.

The weight content of silicon containing fibers with a length of less than 1000 μm in the composition after its hardening and after removal of the possible free water is advantageously at least 0.5%. The silica containing fillers, especially fibers, are advantageously treated with a water repellent agent, such as a water repellent coating of less than 10 μm. This coating is for example a fluoro silane coating.

It has now further been observed that by using specific filler, especially a combination of specific fillers, it was possible to increase mechanical properties of the mixture binder/filler(s) and/or the final appearance of the composition after its hardening and/or the fire resistance of the composition. For example, it was observed that swelling of the product could be reduced or prevented after a water absorption.

It has been observed that the presence of at least 0.5% by weight (dry content), preferably at least 1% by weight of silicon containing fibers with a length of less than 1000 μm, advantageously silicon containing fibers non reactive with the binder or substantially non reactive with the binder, it was possible to prevent the formation of any cracks at the surface of the hardened composition, as well as advantageously in the body of the hardened composition, even if the hardened composition has a high thickness, such as a thickness of more than 2 mm, advantageously of more than 5 mm, such as a thickness comprised between 10 mm and 50 mm.

Advantageously, the composition comprises silicon containing fibers with an average (in weight) length of less than 500 μm, the weight content of silicon containing fibers with an average length of less than 500 μm in the composition after its hardening and after removal of the possible free water (free water is water present in the composition, such as in the hardened composition, but which can be removed in a drying step at a temperature of 100° C.) being of at least 0.5% (i.e. a dry weight content).

According to a preferred embodiment, the composition comprises silicon containing fibers with an average (in weight) length of more than 10 μm, advantageously of more than 20 μm, preferably comprised between 25 μm and 300 μm, most preferably between 50 μm and 250 μm.

According to an advantageous embodiment, the silicon containing fibers with a length of less than 1000 μm, advantageously with an average (in weight) length of less than 500 μm, are substantially not reactive with the binder, preferably not reactive with the binder, i.e. acting as a pure filler. Substantially not reactive silicon containing fibers are fibers characterized in that less than 10% by weight, advantageously less than 5% by weight, preferably less than 1% by weight, most preferably less than 0.5% by weight, of the silicon containing fibers is chemically reacted with the binder, for making for example one or more chemical bonds between fibers and the binder.

According to embodiments, after hardening and removal of free water, the composition comprises from 1% up to 75% by weight, advantageously from 2% up to 25% by weight, silicon containing fibers with a length of less than 1000 μm, advantageously with an average (in weight) length of less than 500 μm.

Silica containing fibers are for example natural fibers, possibly treated, synthetic fibers, mineral fibers, and mixtures thereof. Natural fibers are preferred, such as wood fiber, straw fiber, rice husk or bran fibers, mixtures thereof. The natural fibers are advantageously heat treated, for example at temperature higher than 400° C., such as at a temperature higher than 700° C. or 800° C., advantageously in an atmosphere rich in Nitrogen or in a nitrogen atmosphere. Said heat treatment is preferably carried after a drying step. Rice bran or rice husk are preferred silica containing fibers used in the composition of the invention, said fibers being advantageously defatted and dried. When said fibers are burned and carbonized in a nitrogen gas rice bran ceramic fiber are produced. Possibly some phenolic resin is added to the rice bran or rice husk before the carbonizing and burning step. Possibly the phenolic resin can be mixed with rice bran so as to prepare or form rice bran containing fibers or filaments, the latter fibers or filament after drying being carbonized and burnt (for example at a temperature of 300 to 1100° C. during a time sufficient for the formation of ceramics). The silica containing fibers are advantageously ceramic silica containing fibers. Such fibers, especially rice bran ceramic fibers, have a high strength, a high hardness, a low density, a low friction (hereby the fibers can easily flow the one with respect to the other, whereby facilitating the mixing step).

Silica containing fibers are advantageously treated with a water repellent agent, such as a water repellent coating of less than 10 μm. This coating is for example a fluoro silane coating.

According to a preferred embodiment, the composition further comprises silica flour with a particle size of less than 500 μm, advantageously comprised between 2 and 400 μm, the weight content of silica flour in the composition after its hardening and after removal of the possible free water being of at least 0.5%. Said silica flour content is advantageously comprised between 1 and 10% by weight of the composition after its hardening and removal of free water (water which can be removed with a heating step at a temperature of 100° C.) (i.e. a dry weight content).

Preferably, the composition comprises silica flour with an average (in weight) particle size comprised between 2 and 100 μm, advantageously between 5 and 60 μm, preferably between 10 and 50 μm, the weight content of silica flour in the composition after its hardening and after removal of the possible free water being comprised between 1 and 10%, advantageously between 2 and 8%.

According to a more specific embodiment, the composition with or without (advantageously with) silica flour further comprises crystallized alumina silicate particles which are substantially not reactive with the binder and which have an average (in weight) particle size comprised between 5 and 100 μm, the weight content of crystallized alumina silicate in the composition after its hardening and after removal of the possible free water being comprised between 1 and 10%, advantageously between 2 and 8%.

According to an advantageous embodiment, the weight ratio calcium silicate site/SiO₂ present in the alumina-silica phosphate bonds is greater than 1, preferably greater than 1.5.

Advantageously, the calcium silicate sites are calcium meta silicate sites having a substantially acicular nature with a length/diameter ratio from 2/1 to 50/1, advantageously from 3/1 to 20/1.

Preferably, the calcium meta silicate sites has an average length (average in weight) from 10 μm to 10 mm, advantageously from 50 μm to 5 mm, such as 100 μm, 300 μm, 500 μm.

The calcium silicate sites act preferably as cross-linking sites for alumina-silica phosphate bonds.

According to an embodiment, the alumina-silca phosphate bonds have a ratio Al₂O₃/SiO₂ ranging from 0.3:1 and 10:1, advantageously from 0.6:1 and 6:1.

According to an advantageously embodiment, the weight ratio calcium silicate sites/alumina-silica phosphate bonds is comprised between 0.1 and 1.1, advantageously between 0.3 and 0.9, preferably between 0.4 and 0.7.

The composition of the invention can also comprise one or more further filler(s) and/or reinforced materials.

The composition, as well as the binder of the invention can be used for attaching two elements together, i.e. as glue, heat resistant glue or sealant.

The invention relates also to a composition comprising at least one inorganic binder of the invention and an organic foamed material.

Organic foamed material means organic material adapted to be converted into a foam, organic material starting or during its foaming, as well as organic material after being foamed.

The organic foam can be with open cell, with closed cells or a mixture of open and closed cells. Preferably, the organic foam after its foaming is essentially formed with closed cells.

The organic foamed material is advantageously a carbon containing foamed material. Preferably, the organic foamed material comprises polyurethane.

The weight ratio (on dry basis) inorganic binder/organic foam material is advantageously comprised between 0.01 and 10, preferably between 0.05 and 1, most preferably between 0.1 and 0.5.

The organic foamed material and the inorganic binder are advantageously substantially homogeneously mixed together.

In a specific embodiment, the inorganic binder forms a first net or structure or web, while the organic foamed material forms a second net or structure or web, whereby the first and second nets, structures or webs are mixed the one into the other, advantageously are embraced the one into the other.

The composition after foaming has advantageously a density of less than 1.3, advantageously comprised between 0.1 and 1.1, most preferably between 0.2 and about 1.

The composition can comprise one or more fillers, such as a filler as disclosed here before for the first composition of the invention. Such a filler is advantageously silicon containing fibers.

### Product

The invention relates also to a product comprising at least a hardened layer comprising an inorganic binder of the invention as disclosed here above in the paragraph relating to the binder, but preferably at least a hardened layer having the composition of the invention as disclosed in the paragraph relating to the composition of the invention.

The binder/composition of the invention is suitable for preparing product having a light weight (such a weight from 70 to 140 kg/m³) or a heavy weight (such as weight of 2,000 kg/m³ or even more).

Products of the invention have high mechanical properties, such as one or more of the following properties (preferably several of said properties): compression strength of more than 40 N/mm², bending strength of more than 10 N/mm², very low heat of combustion (less than 500 KJ/kg, advantageously less than 100 KJ/kg, method used: ASTM D 2015 and BS EN ISO 1716), a high modulus of rupture (such as more than 10 MPa, for example between 12 and 20 MPa, method of analysis: NBN EN 196-1), a high compressive strength (more than 50 MPa, such as from 70 to 100 MPa, method of analysis: NBN EN 196-1), a high Young's modulus (more than 5000 MPa, such as between 8000 and 15000 MPa, method of analysis: NBN EN 196-1), absence of swelling even for water absorption from 10% up to 30% depending of the porosity, etc.

Products of the invention can be used as insulating materials (as panels, sheets, granules, etc), fire protection material, heat protection material, chemical protection material, buildings material (such as bricks, concrete, etc.), for making molds, shaping, casting and moldings products, tiles, roofing sheet, coating layers, inner layer, laminated products, metallic profile, aluminum profile, steel profile or beam, metal band or plate, flexible membrane, polyethylene web. Polymer layer (polyurethane, latex, etc.), etc. Specific examples are: roofing sheet, insulation panels, coating surface material

Wear resistant tile, high strength building elements, fire and heat resistant elements, adhesive material, sealants, slates, laminated elements, joint compounds, refractory, mineral fibers, etc.

The invention relates also more precisely to a product made at least partly or associated at least partly to a hardened composition of the invention, as disclosed here above. For example the product can be a support provided with a coating layer with a thickness for example of 0.01 to 100 mm, or even more.

In specific embodiment, the coating layer has an average thickness of less than 5 mm, especially of less than 2 mm.

The product can also have the form of a laminated product, an inner layer being made from a composition of the invention, said inner layer having for example a thickness of 0.5 mm up to 100 mm, or even more.

According to an embodiment, the hardened layer covers at least partly a face of a support element. One or more faces of the support can be provided with a hardened layer. The thickness of the layer is advantageously lower than 10 mm, such as lower than 5 mm, such as 4 mm, 3 mm, 2 mm, 1 mm, 500 μm, 250 μm, 100 μm, depending on the properties which are required.

According to an advantageous embodiment, the hardened layer covers at least partly a face of a support comprising a core which can be subjected to a water swelling. It has been observed that by coating already one face of a plate (which can be subjected to a water swelling) with a composition of the invention, it was possible to obtain after hardening of the composition, a product which has a reduced swelling even after being dipped in water for 72 hours at 20° C. Tests made on commercial wood fiber composite material with a swelling of 37% after being dipped in water for 72 hours at 20° C., have shown that by providing one or more faces of the material with a thin hardened layer of the composition of the invention, it was possible to reduce the swelling to less than 10%, advantageously less than 6%, preferably less than 2%.

According to a specific embodiment, at least partly a face not covered by a hardened layer of the invention is provided with a water repellent coating, advantageously silicon containing water repellent coating, such as a fluoro silicon coating (fluoro silane, etc. such as fluorosilane marketed by 3M as water repellent agent, such as the product Scotchgard®).

The thickness of the water repellent coating is advantageously less than 500 μm, such as less than 250 μm, preferably less than 150 μm, most preferably less than 100 μm, for example less than 50 μm, or even lesser, such as less than 20 μm or even less than 10 μm.

According to a more specific embodiment, substantially all the faces not covered with the hardened layer are provided with a water repellent coating.

According to an embodiment, the support has two substantially parallel faces (top and bottom faces or major faces, front and rear faces) connected the one to the other by lateral faces, whereby said lateral faces (bottom/top or front/rear faces) have a higher water permeability than the two substantially parallel faces. In said embodiment, the lateral faces of the support are provided with a water repellent coating. The water repellent coating on said lateral faces covers also at least a portion of the front/rear faces along their edges or at least a portion of the hardened layer adjacent to the edges of said front and rear faces. The water repellent coating can be carried out before and/or after providing the support with the hardened layer of the invention.

### The Kit

The invention relates also to a kit for the preparation of inorganic binder of the invention or a composition according to the invention, said kit comprising:
a first container of bag containing a water insoluble calcium silicate, and
at least one or more second containers or bags containing compounds for preparing an acid alumina-silica phosphate solution comprising solubilized silica,
   whereby at least one container selected from the group consisting of the first container the second container(s) comprises an adhesive resin for enhancing hydraulic cement adhesion.

Advantageously, the second container(s) comprises at least one acid so that the pH of said acid alumina-silica phosphate solution measured at 20° C. is advantageously less than 2, preferably less than 1.5, more preferably less than 1, especially less than 0.5.

The acid pH is advantageously obtained by using phosphoric acid or an acid mixture containing at least phosphoric acid. Preferably, substantially only phosphoric acid is used as mineral acid, most preferably as acid for lowering the pH of the solution to less than 2. The acid can be in a distinct container or can be used for the preparation of an acid solution containing solubilized alumina-silica phosphate, i.e. a ready to mix solution.

The adhesive resin for enhancing hydraulic cement adhesion is advantageously an adhesive resin as disclosed in the binder of the invention.

Preferably, the adhesive resin for enhancing hydraulic cement adhesion is selected from the group consisting of acrylic latexes, rubber latexes, vinyl acetate copolymers, polyvinyl acetate polymers, polyvinyl acetate copolymers, and mixtures thereof.

According to an advantageous embodiment, at least one container selected from the group consisting of the first and second containers comprises at least one surfactant, the weight ratio surfactant/adhesive resin for enhancing hydraulic cement adhesion being lower than 0.1.

The surfactant is preferably a nonionic surfactant.

According to another embodiment, at least one container selected from the group consisting of the first and second containers comprises an adhesive resin for enhancing hydraulic cement adhesion and at least one surfactant, the weight ratio surfactant/adhesive resin for enhancing hydraulic cement adhesion being comprised between 0.01 and 0.05.

According to a preferred embodiment of the kit, the kit comprises:
a container of bag containing a water insoluble calcium silicate, silicon containing fibers with a length of less than 1000 μm, and possibly, but advantageously also silica flour with an average particle size of less than 500 μm, and
one or more containers or bags containing compounds for preparing an acid alumina-silica phosphate solution or containing an alumina-silica phosphate solution, the pH of said solution measured at 20° C. being less than 1.5, advantageously less than 1, preferably less than 0.5, in which silica is solubilized.

It has been observed that the premix of water insoluble calcium silicate with silicon containing fibers with a length of less than 1000 μm was in a form enabling an easily and quick mixing with an acid alumina-silica phosphate solution.

The water insoluble calcium silicate, the silicon containing fibers, the silica flour used in the kit has advantageously one or more characteristics as disclosed here above in the binder and compositions of the invention.

The alumina-silica phosphate solution has advantageously a weight ratio Al₂O₃/SiO₂ ranging from 0.3:1 and 10:1, preferably from 0.6:1 and 6:1.

The kit advantageously further comprises a container with a composition containing a water repellent agent, advantageously in the form of a solution, preferably a ready to use solution. Such a composition is for example a water based solution or a solvent based solution containing a water repellent silane, preferably a fluoro silane.

### The Process for the Preparation of a Binder/composition of the Invention

A further subject matter of the invention is the preparation of an inorganic binder having calcium silicate sites which are connected the one with the other by alumina-silica phosphate bonds, the calcium silicate sites acting as cross-linking sites for the alumina-silica phosphate bonds with a weight ratio Al₂O₃/SiO₂ ranging from 0.3:1 and 10:1, in which water insoluble calcium silicate particles are mixed (a) with an acid alumina-silica phosphate solution at a temperature lower than 50° C., said acid alumina-silica phosphate solution comprising solubilized SiO2 and having a pH of less than 2, said alumina-silica phosphate solution having a weight ratio Al₂O₃/SiO₂ ranging from 0.3:1 and 10:1, and (b) with an adhesive resin for enhancing hydraulic cement adhesion, so as to form a reacting binding composition, whereby the amount of adhesive resin for enhancing hydraulic cement adhesion is adapted so that the binding reacting composition after drying comprises from 0.01% and 2% of weight as dry matter of an adhesive resin for enhancing hydraulic cement adhesion.

The adhesive resin is preferably an adhesive resin as disclosed for the binder of the invention.

Advantageously, water insoluble calcium silicate particles are mixed with an acid alumina-silica phosphate solution at a temperature lower than 50° C., said acid alumina-silica phosphate solution comprising solubilized SiO2 and having a pH of less than 1.5, said alumina-silica phosphate solution having a weight ratio Al₂O₃/SiO₂ ranging from 0.6:1 and 6:1.

Preferably, the weight ratio water insoluble calcium silicate particles/solubilized SiO₂ present in the alumina-silica phosphate solution is greater than 1.

According to an advantageous embodiment, the adhesive resin is at least substantially homogeneously dispersed into the reacting binding composition.

Preferably, the reacting binding composition comprises after drying from 0.05% to 1% by weight of an adhesive resin for enhancing hydraulic cement adhesion.

According to a preferred embodiment, the adhesive resin for enhancing hydraulic cement adhesion is selected from the group consisting of acrylic latexes, rubber latexes, vinyl acetate copolymers, polyvinyl acetate polymers, polyvinyl acetate copolymers, and mixtures thereof.

According to another detail, the reacting binding composition comprises at least one surfactant, the weight ratio surfactant/adhesive resin for enhancing hydraulic cement adhesion being lower than 0.1.

Preferably, the surfactant is nonionic surfactant.

In a specific embodiment, the reacting binding composition comprises at least one surfactant, the weight ratio surfactant/adhesive resin for enhancing hydraulic cement adhesion being comprised between 0.01 and 0.05.

Advantageously, the hardening of the reacting binding composition is carried out at a temperature comprised between 0° C. and 50° C. Higher temperature can be used, but are not preferred.

Preferably, the reacting binding composition is hardened under pressure.

The invention relates further to a process for preparing a composition of the invention, in which a reacting binding composition formed by mixing water insoluble calcium silicate particles with an acid alumina-silica phosphate solution at a temperature lower than 50° C., said acid alumina-silica phosphate solution comprising solubilized SiO2 and having a pH of less than 2, said alumina-silica phosphate solution having a weight ratio Al₂O₃/SiO₂ ranging from 0.3:1 and 10:1, is mixed with a foamable organic composition and with an adhesive resin for enhancing hydraulic cement adhesion, the so obtained reacting mixture after drying comprising from 0.01% and 2% of weight as dry matter of an adhesive resin for enhancing hydraulic cement adhesion

The adhesive resin is preferably an adhesive resin as disclosed for the binder of the invention.

Advantageously, the adhesive resin is at least substantially homogeneously dispersed into the reacting mixture.

Preferably, the reacting mixture comprises after drying from 0.05% to 1% by weight of an adhesive resin for enhancing hydraulic cement adhesion.

According to a preferred embodiment, the adhesive resin for enhancing hydraulic cement adhesion is selected from the group consisting of acrylic latexes, rubber latexes, vinyl acetate copolymers, polyvinyl acetate polymers, polyvinyl acetate copolymers, and mixtures thereof.

According to an embodiment, the reacting mixture comprises at least one surfactant, the weight ratio surfactant/adhesive resin for enhancing hydraulic cement adhesion being lower than 0.1.

Preferably, the surfactant is nonionic surfactant.

According to a further embodiment, the reacting mixture comprises at least one surfactant, the weight ratio surfactant/adhesive resin for enhancing hydraulic cement adhesion being comprised between 0.01 and 0.05.

According to an advantageous detail, the hardening of the reacting mixture is carried out at a temperature comprised between 0° C. and 50° C.

Preferably, the reacting mixture is hardened under pressure.

According to a specific embodiment of the processes for the preparation of a binder/composition according to the invention, water insoluble calcium silicate particles are mixed with an acid alumina-silica solution at a temperature lower than 50° C., said acid alumina-silca solution having a pH less than 2, advantageously less than 1.5, for example comprised between 0.1 and 1.5, preferably comprised between 0.5 and 1.5.

The acid pH is advantageously obtained by using phosphoric acid or an acid mixture containing at least phosphoric acid. Preferably, substantially only phosphoric acid is used as mineral acid, most preferably as acid for lowering the pH of the solution to less than 2.

In the processes of the invention, the alumina-silica phosphate solution has advantageously a ratio Al₂O₃/SiO₂ ranging from 0.3:1 and 10:1, preferably from 0.6:1 and 6:1.

In the processes of the invention, a filler and/or a reinforced material is advantageously mixed with the calcium silicate particles before being mixed with the acid alumina-silica phosphate solution and/or a filler and/or a reinforced material is mixed to the mixture calcium silicate/alumina—silica phosphate solution, before or during its hardening.

Preferably, the hardening of the binder is carried out at a temperature comprised between 0° C. and 50° C., possibly under pressure.

The binder of the invention is prepared by using an acid alumina-silica phosphate solution, said solution is advantageously prepared by reacting aluminum oxide powder (size advantageously lower than 50 μm, preferably lower than 30 μm, for example from 5 to 25 μm) with a purity of more than 95%, preferably more than 99%, silica powder (size advantageously lower than 50 μm, preferably lower than 30 μm, for example from 10 to 25 μm) with a purity of more than 95%, preferably of more than 99%, and phosphoric acid as an aqueous phosphoric acid or in presence of an aqueous medium. The phosphoric acid has preferably a purity of more than 95%, most preferably of more than 99%. Phosphoric acid is available in various concentration. Preferably, the phosphoric acid will be a phosphoric aqueous solution with a phosphoric acid concentration of more than 75%, preferably of more than 85%. Preferably, the silica powder is first mixed with the phosphoric acid and then the alumina particles are added.

The acid alumina-silica phosphate solution contains possibly some other acids, such as organic acid, strong mineral acid, etc, however, in this case, the content of such acid will preferably be less than 10% of the phosphoric acid content of the solution.

Instead of using aluminum oxide, it is possible to use aluminum phosphate, aluminum hydroxide, etc. However, aluminum oxide is preferred.

Instead of using silica, preferably precipitated silica particles, it is possible to use waste material issuing from glass bottles.

Possibly the aqueous phosphoric acid solution contains other solvents, such as alcohol, etc.

When a product comprising foamed inorganic binder is desired, more water or solvent will be used for decreasing as much as possible the viscosity.

The acid alumina silica phosphate solution has advantageously a pH lower than 2, preferably lower than 1.

It has been observed that when using silica particles for the preparation of the acid alumina phosphate solution with a pH lower than 2, most preferably lower than 1, the dissolution of alumina particles was improved. The presence of solubilized SiO₂ in the acid solution was also improving the formation of the bonds when adding the water insoluble calcium silicate particles. Even, if some calcium silicate particles are solubilized due to the low pH, some calcium silicate particles remains insoluble, due for example to the increase of pH to a value comprised between 3 and 6.

According to a specific embodiment of the processes, silicon containing fibers with a length of less than 1000 μm are mixed with water insoluble calcium silicate particles, prior to or during the mixing of water insoluble silicate particles with an acid alumina-silica phosphate solution and/or in which silicon containing fibers with a length of less than 1000 μm are mixed with the binding mixture before its complete hardening.

Preferably, the binding mixture with the adhesive resin is first prepared and then the silicon containing fibers are added. Said addition is carried out when the binding mixture is still sufficiently liquid or pourable by gravity. Possibly before and/or during the addition of the fibers, water can be added for controlling the viscosity. Possibly the silicon containing fibers are prewetted before being added to the binding mixture.

According to an advantageous embodiment, silica flour is added to the water insoluble calcium silicate particles, prior to or during the mixing of water insoluble silicate particles with an acid alumina-silica phosphate solution and/or to the binding mixture before its complete hardening, said addition being carried out prior, during or after the addition of silicon containing fibers.

Preferably, the silicon containing fibers and the silica flour are premixed before being added to the acid alumina-silica phosphate solution or to the binding mixture. According to a possible embodiment, the insoluble calcium silicate particles, the silicon containing fibers and the silica flour are premixed before being added to and mixed with the acid alumina-silica phosphate solution.

Advantageously, the weight ratio water insoluble calcium silicate particles/solubilized SiO₂ present in the alumina-silica phosphate solution is greater than 1, preferably greater than 1.5.

Preferably, the hardening of the binder/composition is carried out at a temperature comprised between 0° C. and 50° C., such as advantageously between 10 and 30° C.

The binder/composition is preferably hardened under pressure, such as under a pressure comprised between 2 10⁵ Pa and 100 10⁵ Pa, for example 5 10⁵ Pa, 10⁶ Pa, 2 10⁶ Pa, etc.

The amount of calcium silicate added to the acid silica alumina phosphate solution is advantageously such that the weight ratio calcium silicate/SiO₂ present in the acid solution is comprised between 1 and 5, advantageously comprised between 1.5 and 3.5.

Preferably, the amount of calcium silicate added to the acid silica alumina phosphate solution is such that the weight ratio calcium silicate/SiO₂ present in the acid solution is greater than 2.

According to a preferred embodiment, the silica used for the preparation of the acid silica alumina phosphate solution is precipitated silica.

The acid alumina-silca solution before its mixing with insoluble calcium silicate particles has advantageously a pH of less than 2, preferably less than 1.5, for example comprised between 0.1 and 1.5, preferably comprised between 0.5 and 1.5. The acid pH is advantageously obtained by using phosphoric acid or an acid mixture containing at least phosphoric acid. Preferably, substantially only phosphoric acid is used as mineral acid, most preferably as acid for lowering the pH of the solution to less than 2.

The calcium silicate particles are advantageously calcium meta silicate particles having a substantially acicular nature with a length/diameter ratio from 2/1 to 50/1, advantageously from 3/1 to 20/1.

The calcium meta silicate particles have preferably an average length from 10 μm to 10 mm, advantageously from 50 μm to 5 mm.

According to a preferred embodiment, the calcium silicate particles act as cross-linking sites for alumina-silica phosphate bonds. It seems also that the presence of insoluble calcium silicate particles catalyzes the formation of alumina-silica phosphate bonds.

In the processes of the invention, the alumina-silica phosphate solution has advantageously a weight ratio Al₂O₃/SiO₂ ranging from 0.3:1 and 10:1, preferably from 0.6:1 and 6:1.

For example, the weight ratio calcium silicate particles/alumina-silica phosphate solution is comprised between 0.1 and 1.1, preferably from 0.3 and 0.9, most preferably between 0.4 and 0.7.

In the processes of the invention, various filler and/or a reinforced material can be mixed with the calcium silicate particles before being mixed with the acid alumina-silica phosphate solution, and/or a filler and/or a reinforced material is mixed to the mixture calcium silicate/alumina—silica phosphate solution, before its or during its hardening.

Examples of fillers or reinforced materials which can be mixed with the binder before its preparation, during its preparation, before its hardening or during its hardening are:
waste materials, such as finely divided waste material, for example fuel ashes, fly ashes, buildings waste materials, etc.
flake-like materials such as mica, etc.,
silica sand, silica flour,
coloring agents or materials, such as inorganic coloring agents, pigments, etc.
cellulose and/or protein base fibers, such as natural fibers, flax, chip, straw, hemp, wool fibers, etc.
synthetic fibers, such as organic synthetic fibers, inorganic synthetic fibers, such as polyesters, polypropylene, glass and ceramic fibers, etc.
natural and synthetic organic base waste materials, such as saw dust, rice husk, straw and recycled organic waste,
natural fibers of mineral origin,
natural material, possibly treated (for example heat treated), such as perlite, vermiculite, etc.
etc.
mixtures thereof.

Additives can be added to the binder/composition before its preparation, during its preparation, before its hardening or during its hardening, such additives are for example:
foaming agents, such as water peroxide, organic peroxide, etc.
viscosity regulating agent, such as superplasticizer
material for improving the impermeability or the water repulsion such as lignosulfonates and silica fume
etc.
mixtures thereof.

Possibly, additives or fillers can be added during or after the hardening, for example for making a top coat.

The binder/composition of the invention is preferably prepared by using an acid alumina-silica phosphate solution, said solution is advantageously prepared by reacting aluminum oxide powder (size advantageously lower than 50 μm, preferably lower than 30 μm, for example from 5 to 25 μm) with a purity of more than 95%, preferably more than 99%, silica powder (size advantageously lower than 50 μm, preferably lower than 30 μm, for example from 10 to 25 μm) with a purity of more than 95%, preferably of more than 99%, and phosphoric acid as an aqueous phosphoric acid or in presence of an aqueous medium. The phosphoric acid has preferably a purity of more than 95%, most preferably of more than 99%. Phosphoric acid is available in various concentration. Preferably, the phosphoric acid will be a phosphoric aqueous solution with a phosphoric acid concentration of more than 75%, preferably of more than 85%. Preferably, the silica powder is first mixed with the phosphoric acid and then the alumina particles are added.

The acid alumina-silica phosphate solution contains possibly some other acids, such as organic acid, strong mineral acid, etc, however, in this case, the content of such acid will preferably be less than 10% of the phosphoric acid content of the solution.

Instead of using aluminum oxide, it is possible to use aluminum phosphate, aluminum hydroxide, etc. However, aluminum oxide is preferred.

Instead of using silica, preferably precipitated silica particles, it is possible to use waste material issuing from glass bottles.

Possibly the aqueous phosphoric acid solution contains other solvents, such as alcohol, etc.

When a foamed product is desired, more water or solvent will be used for decreasing as much as possible the viscosity. It is also possible to obtain a foaming product by applying the acid composition on a base containing support or on an alkaline support.

The acid alumina silica phosphate solution has advantageously a pH lower than 2, preferably lower than 1.

It has been observed that when using silica particles for the preparation of the acid alumina phosphate solution with a pH lower than 2, most preferably lower than 1, the dissolution of alumina particles was improved. The presence of solubilized SiO₂ in the acid solution was also improving the formation of the bonds when adding the water insoluble calcium silicate particles. Even, if some calcium silicate particles are solubilized due to the low pH, some calcium silicate particles remains insoluble, due for example to the increase of pH to a value comprised between 3 and 6.

### EXAMPLES

Details and characteristics of the invention will appear from the description of the following examples.

In said examples, the following products have been used:

WATER: water with a low calcium/magnesium content (less than 100 ppm)
SiO₂: precipitated SiO₂ particles with an average size of 10-15 μm-purity of 99%
Al₂O₃: powder with an average particle size of 10-15 μm-purity of 99%
Phosphoric acid: aqueous solution containing 90% phosphoric acid
Calcium silicate:calcium meta silicate powder, water insoluble, acicular nature, length of 1 mm, diameter 100 μm.
Rice Husk fibers (RHF1): dried natural fibers (water content less than 2%) with an average (in weight) length of about 100 μm.
Rice Husk fibers (RHF2): dried natural fibers (water content less than 2%) with an average (in weight) length of about 200 μm.
Rice bran ceramic fiber (RBCF1): defatted bran mixed with phenolic resin, shaped in filament, dried and carbonized and burnt under nitrogen atmosphere at 800° C., the fibers having a length of about 100 μm.
Rice bran ceramic particles (RBC): defatted bran mixed with phenolic resin, powdered, dried and carbonized and burnt under nitrogen atmosphere at 800° C., the powder having an average particle size (average in weight) of about 50 μm.
Crystallized alumina silicate (CAS): not reactive with the phosphate solution, the particles having an average particle size of 50 μm (average in weight).
Silica Flour (SF): average (in weight) particle size of about 30 μm
Silica fume (Sf): average (in weight) particle size 50 μm.
Glass fiber (GF): glass fibres with a length of 50 μm to 250 μm, which have been treated with a water repellent agent (fluoro silane)
Acrylic emulsion polymer (AEP): UCAR® Latex 412 (Dow) an adhesive resin for hydraulic cement. The emulsion has a pH at 20° C. of about 7.5. The resin solid content of the emulsion is about 48% by weight. By using the concrete test method disclosed in the description of the binder of the invention, the acrylic polymer emulsion enables to achieve the following properties:

| | Concrete with | Concrete without |
|---|---|---|
| Properties after curing 28 days | latex | latex |
| Abrasion resistance % loss | 5.1 | 0.4 |
| Tensile strength, psi | 390 | 700 |
| Compressive strength, psi | 4600 | 5200 |
| Flexural strength, psi | 800 | 1560 |
| Ceramic tile shear bond, psi | 230 | 420 |

Styrene butadiene rubber latex admixture (SBR): emulsion of styrene-butadiene rubber in water with a resin solid content of about 47%. The pH was controlled to about 8. Said latex was suitable for enhancing portland cement adhesion, as well as for enhancing the tensile strength, the compressive strength, and the flexural strength.
Polyacrylic emulsion (PAE): an adhesive resin water emulsion (Polysar latex 1186) with a polyacrylic weight content of about 50%, a pH of about 7.5 and a density of about 1.1. Said polyacrylic latex was suitable for enhancing portland cement adhesion, as well as for enhancing the tensile strength, the compressive strength, and the flexural strength.

### Examples of Binders

The binders have been prepared by adding SiO₂ particles to phosphoric acid. After dissolution of the SiO₂ particles, Al₂O₃ particles were added. An acid alumina silica phosphate aqueous solution was so prepared. The pH of said acid solution was then measured at 20° C. Possibly some water was added.

To said acid solution, an adhesive resin aqueous emulsion was added and mixed. Thereafter, calcium silicate particles was added to said mixture. 5 to 10 minutes after the addition of calcium silicate particles, the binder can be hardened. Said hardening can be made at room temperature. In order to control the viscosity of the mixture, water can be added.

The following table gives the composition of the binders prepared.

TABLE 1
Binder with AEP as adhesive resin (the AEP content is given as dry or solid content)

| Binder | 1 | 2 | 3 | 4 | 5 | 6 | 7 | 8 | 9 | 10 |
|---|---|---|---|---|---|---|---|---|---|---|
| SiO₂ (g) | 35 | 16 | 21 | 13.6 | 46.2 | 60 | 182 | 130.8 | 97.2 | 233 |
| Al₂O₃ | 24 | 23 | 13 | 50.8 | 30.8 | 60 | 136.5 | 21.8 | 58.1 | 46.6 |
| (g) | | | | | | | | | | |
| Phosphoric | 141 | 141 | 167 | 123 | 135.6 | 180 | 182 | 87.4 | 184.7 | 350.4 |
| acid | | | | | | | | | | |
| (g) | | | | | | | | | | |
| Molar | 0.43 | 0.2 | 0.2 | 0.19 | 0.59 | 0.58 | 1.73 | 2.62 | 0.92 | 1.15 |
| Ratio | | | | | | | | | | |
| SiO₂/P₂O₅ | | | | | | | | | | |
| Of the | | | | | | | | | | |
| solution | | | | | | | | | | |
| Calcium | 120 | 100 | 150 | 60 | 100 | 150 | 200 | 140 | 240 | 310 |
| silicate (g) | | | | | | | | | | |
| Water (ml) | 80 | 40 | | | 25 | 60 | 118 | 21 | 71 | 65 |
| AEP (g) | 0.5 | 0.5 | 0.2 | 1 | 0.7 | 1 | 1 | 0.3 | 1 | 1 |
| pH of the | 0.5 | 0.5 | 0.5 | 0.5 | 0.5 | 0.5 | 0.5 | 0.5 | 0.5 | 0.5 |
| acid | | | | | | | | | | |
| solution | | | | | | | | | | |
| pH of the | 1 | 0.5 | 1 | 0.5 | 0.5 | 1.5 | 1 | 1 | 1.5 | 1.5 |
| solution | | | | | | | | | | |
| after | | | | | | | | | | |
| addition of | | | | | | | | | | |
| the calcium | | | | | | | | | | |
| silicate | | | | | | | | | | |
| Appearance | LS | LS | S-D | S-D | P | LS | LS | S-D | P | P |
| of the | | | | | | | | | | |
| mixture | | | | | | | | | | |
| after the | | | | | | | | | | |
| addition of | | | | | | | | | | |
| the calcium | | | | | | | | | | |
| silicate | | | | | | | | | | |
| (LS, S-D, P)* | | | | | | | | | | |

*LS = Liquid suspension/S-D = Semi-dry/P = Pasty

TABLE 2
binder with SBR as adhesive resin (the SBR content is given as dry or solid content)

| Binder | 1 | 2 | 3 | 4 | 5 | 6 | 7 | 8 | 9 | 10 |
|---|---|---|---|---|---|---|---|---|---|---|
| SiO₂ (g) | 35 | 16 | 21 | 13.6 | 46.2 | 60 | 182 | 130.8 | 97.2 | 233 |
| Al₂O₃ | 24 | 23 | 13 | 50.8 | 30.8 | 60 | 136.5 | 21.8 | 58.1 | 46.6 |
| (g) | | | | | | | | | | |
| Phosphoric | 141 | 141 | 167 | 123 | 135.6 | 180 | 182 | 87.4 | 184.7 | 350.4 |
| acid | | | | | | | | | | |
| (g) | | | | | | | | | | |
| Molar | 0.43 | 0.2 | 0.2 | 0.19 | 0.59 | 0.58 | 1.73 | 2.62 | 0.92 | 1.15 |
| Ratio | | | | | | | | | | |
| SiO₂/P₂O₅ | | | | | | | | | | |
| Of the | | | | | | | | | | |
| solution | | | | | | | | | | |
| Calcium | 120 | 100 | 150 | 60 | 100 | 150 | 200 | 140 | 240 | 310 |
| silicate (g) | | | | | | | | | | |
| Water (ml) | 80 | 40 | | | 25 | 60 | 118 | 21 | 71 | 65 |
| SBR (g) | 0.5 | 0.5 | 0.2 | 1 | 0.7 | 1 | 1 | 0.3 | 1 | 1 |
| pH of the | 0.5 | 0.5 | 0.5 | 0.5 | 0.5 | 0.5 | 0.5 | 0.5 | 0.5 | 0.5 |
| acid | | | | | | | | | | |
| solution | | | | | | | | | | |
| pH of the | 1 | 0.5 | 1 | 0.5 | 0.5 | 1.5 | 1 | 1 | 1.5 | 1.5 |
| solution | | | | | | | | | | |
| after | | | | | | | | | | |
| addition of | | | | | | | | | | |
| the calcium | | | | | | | | | | |
| silicate | | | | | | | | | | |
| Appearance | LS | LS | S-D | S-D | P | LS | LS | S-D | P | P |
| of the | | | | | | | | | | |
| mixture | | | | | | | | | | |
| after the | | | | | | | | | | |
| addition of | | | | | | | | | | |
| the calcium | | | | | | | | | | |
| silicate | | | | | | | | | | |
| (LS, S-D, P)* | | | | | | | | | | |

*LS = Liquid suspension/S-D = Semi-dry/P = Pasty

TABLE 3
binder with PAE as adhesive resin (the PAE content is given as dry or solid content)

| Binder | 1 | 2 | 3 | 4 | 5 | 6 | 7 | 8 | 9 | 10 |
|---|---|---|---|---|---|---|---|---|---|---|
| SiO₂ (g) | 35 | 16 | 21 | 13.6 | 46.2 | 60 | 182 | 130.8 | 97.2 | 233 |
| Al₂O₃ | 24 | 23 | 13 | 50.8 | 30.8 | 60 | 136.5 | 21.8 | 58.1 | 46.6 |
| (g) | | | | | | | | | | |
| Phosphoric | 141 | 141 | 167 | 123 | 135.6 | 180 | 182 | 87.4 | 184.7 | 350.4 |
| acid | | | | | | | | | | |
| (g) | | | | | | | | | | |
| Molar | 0.43 | 0.2 | 0.2 | 0.19 | 0.59 | 0.58 | 1.73 | 2.62 | 0.92 | 1.15 |
| Ratio | | | | | | | | | | |
| SiO₂/P₂O₅ | | | | | | | | | | |
| Of the | | | | | | | | | | |
| solution | | | | | | | | | | |
| Calcium | 120 | 100 | 150 | 60 | 100 | 150 | 200 | 140 | 240 | 310 |
| silicate (g) | | | | | | | | | | |
| Water (ml) | 80 | 40 | | | 25 | 60 | 118 | 21 | 71 | 65 |
| PAE (g) | 0.5 | 0.5 | 0.2 | 1 | 0.7 | 1 | 1 | 0.3 | 1 | 1 |
| pH of the | 0.5 | 0.5 | 0.5 | 0.5 | 0.5 | 0.5 | 0.5 | 0.5 | 0.5 | 0.5 |
| acid | | | | | | | | | | |
| solution | | | | | | | | | | |
| pH of the | 1 | 0.5 | 1 | 0.5 | 0.5 | 1.5 | 1 | 1 | 1.5 | 1.5 |
| solution | | | | | | | | | | |
| after | | | | | | | | | | |
| addition of | | | | | | | | | | |
| the calcium | | | | | | | | | | |
| silicate | | | | | | | | | | |
| Appearance | LS | LS | S-D | S-D | P | LS | LS | S-D | P | P |
| of the | | | | | | | | | | |
| mixture | | | | | | | | | | |
| after the | | | | | | | | | | |
| addition of | | | | | | | | | | |
| the calcium | | | | | | | | | | |
| silicate | | | | | | | | | | |
| (LS, S-D, P)* | | | | | | | | | | |

*LS = Liquid suspension/S-D = Semi-dry/P = Pasty

In the process of the invention, the amount of calcium silicate added to the acid silica alumina phosphate solution is such that the weight ratio calcium silicate /SiO₂ present in the acid solution is advantageously greater than 1, preferably greater than 1.5, most preferably greater than 2, for example comprised between 1 and 5, advantageously comprised between 1.5 and 3.5.

The binders 3 to 5 and 8 to 10, after their preparation, are mixed with water so as to have a more liquid appearance, whereby the addition of fibers and other particles is more adequate.

### Examples of Compositions of the Invention

The binder n°2 of Table 1 which is liquid after its preparation was mixed with various additives and/or filler.

The following tables gives the different additives and fillers used, expressed in part by weight, the binder being expressed as dry matter (without water).

TABLE 4

Product n^{o}

| | 1 | 2 | 3 | 4 | 5 | 6 | 7 | 8 |
|---|---|---|---|---|---|---|---|---|
| Binder (dry | 1 | 1 | 1 | 1 | 1 | 1 | 1 | 1 |
| matter, part | | | | | | | | |
| by weight) | | | | | | | | |
| RHF1 | 0.1 | 0.1 | | | 0.5 | | | |
| RHF2 | | 0.1 | | | | | | |
| RBCF1 | | | 0.2 | | | 0.4 | 0.4 | 0.4 |
| RBC | | | | 0.3 | | | | |
| CAS | | | | | 0.2 | | | |
| SF | 0.02 | 0.02 | 0.05 | 0.05 | 0.1 | 0.1 | 0.1 | 0.1 |
| Sf | | | | | | 0.1 | 0.2 | 0.2 |
| GF | | | | | | 0.5 | 1 | |

| | Product n^{o} | | | | | |
|---|---|---|---|---|---|---|
| | 9 | 10 | 11 | 12 | 13 | 14 |
| Binder (part | 1 | 1 | 1 | 1 | 1 | 1 |
| by volume) | | | | | | |
| Additive | H₂O₂ | Silica | Aluminum | Super | Ligno- | Quartz |
| (Part by volume) | 0.13 | Fume | powder | Plasticizer | Sulfonate | 0.54 |
| | | 0.42 | 0.12 | 0.15 | 0.13 | |
| Filler | Verniculite | Straw | Fly ash | Chip | Flax | Silica |
| (part by volume) | 0.33 | 3 parts | 0.52 | 1.22 | Fiber | Flour |
| | | | | | 0.75 | 0.25 |
| Appearance | Foam, | Low | Foam | Low | Low | Heavy |
| of the product | low | density | Low | density | density | density |
| | density | | density | | | |

For the preparation of said compositions, water can be added for controlling the viscosity of the composition, said viscosity being preferably maintained as low as possible during the mixing step.

Similarly, the binders n°2 of Table 2 and Table 3 were used for the preparation of compositions similar to the compositions 1 to 14 of Table 4.

To the compositions of Table 4, as well to the compositions with the binders n°2 of Table 2 and Table 3, one or more further additives or fillers can be added.

The following table gives possible additives and fillers which can be added to the compositions of the table 1. Said addition is carried out when the composition is sufficient liquid. Possibly some water is added before the addition and/or during the addition of said additives and fillers.

TABLE 5
Examples of possible additive and filler added to one volume of a
composition with a solid content of 25% and 50% by weight

| | | | | | | |
|---|---|---|---|---|---|---|
| Additive | H₂O₂ | Silica | Alumi- | Super | Ligno- | Quartz |
| (Part by | 0.13 | Fume | num | Plasti- | Sulfonate | 0.54 |
| volume) | | 0.42 | powder | cizer | 0.13 | |
| | | | 0.12 | 0.15 | | |
| Filler | Vermic- | Straw | Fly ash | Chip | Flax | Silica |
| (part by | ulite | 3 parts | 0.52 | 1.22 | Fiber | Flour |
| volume) | 0.33 | | | | 0.75 | 0.25 |
| Appearance | Foam, | Low | Foam | Low | Low | Heavy |
| of the | low | density | Low | density | density | Density |
| product | density | | density | | | |

The composition comprising one or more inert fillers are preferably prepared by premixing at least partly the inert fillers with the calcium silicate, before using said calcium silicate for the preparation of the binder. The premix was thus mixed with the acid silica alumina phosphate solution.

### Examples of Coating Operation

### Examples of Coating of a Wood Board

A wood board with a thickness of 20 mm has been cut in samples with a size of 200 mm×200 mm. One sample was used as control sample. Said control sample was dipped in water at 20° C. for 72 hours. The water absorption of the control sample was 46% (i.e. the weight of the wood board was increased by 46% due to the dipping in water, with respect to the weight of the dry board before its dipping—dry meaning a water content of less than 10% by weight in the board), while the swelling of the product was 37% (i.e. the volume of the sample was increased by 37% due to the dipping with respect to the volume of the dry board—dry meaning a water content of less than 10% by weight),

The samples have been submitted respectively to the following treatment.

### Sample 1

Composition 7 of Table 4 has been used just after its preparation for coating the upper face of sample. The coating after drying had a thickness of 2 mm. After its complete curing, the sample was dipped in water (20° C.) for 72 hours. The water absorption was about 25% with a swelling of about 8%.

### Sample 2

Sample 2 was prepared as disclosed for sample 1, except that after coating the front face, the rear face was also coated with a 1-2 mm thick coating (composition 7 of Table 4).

After its complete curing of the two coating layer, the sample was dipped in water (20° C.) for 72 hours. The water absorption was about 20% with a swelling of about 6%.

### Sample 3

Sample 3 was prepared as disclosed for example 2, except that thereafter the four lateral faces of the sample were also provided with a coating layer (composition 7), said layer having a thickness of about 1-2 mm.

After complete curing or hardening of the coating layer, the sample was dipped in water (20° C.) for 72 hours. The water absorption was about 14% with a swelling of about 2%.

### Sample 4

Sample 4 was prepared as disclosed in example 2, except that the lateral faces were treated with a water repellent agent (scotchgard™ 3M).

After the complete curing of the two coating layer and of the water repellent agent, the sample was dipped in water (20° C.) for 72 hours. The water absorption was about 14% with a swelling of about 0%.

### Sample 5

Sample 4 was prepared as disclosed in example 1, except that the lateral faces were treated with a water repellent agent (scotchgard™ 3M).

After the complete curing of the two coating layer and of the water repellent agent, the sample was dipped in water (20° C.) for 72 hours. The water absorption was about 15% with a swelling of about 0-2%.

### Sample 6

Sample 6 was prepared as disclosed in example 2, except that before the coating of the rear and front faces with the composition 7 of Table 4, the lateral faces as well as the edges of the front and rear faces were treated with a water repellent agent. After the complete curing of the two coating layer and of the water repellent agent, the sample was dipped in water (20° C.) for 72 hours. The water absorption was about 14% with a swelling of about 0-2%.

### Sample 7

Sample 7 was prepared as disclosed for sample 3, except that thereafter the hardened layer was further coated with a water repellent agent (scotchgard). After the complete curing of the two coating layer and of the water repellent agent, the sample was dipped in water (20° C.) for 72 hours. The water absorption was about 15% with a swelling of about 0-2%.

### Sample 8

Sample 8 was prepared as disclosed for sample 3, except that before applying the hardened layer of composition 7, all the faces of the sample were coated with a water repellent agent (scotchgard).

After the complete curing of the two coating layer and of the water repellent agent, the sample was dipped in water (20° C.) for 72 hours. The water absorption was about 15% with a swelling of about 0-2%.

The water absorption and swelling tests was repeated with oriented strand board. The conclusions of the samples 1 to 8 were maintained.

The adhesion of the coating layer(s) was excellent. Moreover, no cracks were visible, even if the thickness was very low.

Similarly, further samples similar to samples 1 to 8 were prepared by using the composition n°7 of Table 4 but with another adhesive resin (SBR or PAE). The same conclusions were achieved.

Still further samples were prepared by using the composition n°7, but without glass fibers. The coating layer after drying had no visible cracks. By the use of small amount of adhesive resin in the composition, it was thus possible to prevent the formation of cracks during the drying of the coating layer.

It was also observed that by using the adhesive resin, although in small amount, the thickness of the coating layer, as well as the mechanical property thereof were more uniform, i.e. enabling a still enhancement of mechanical property.

The fire resistance property of the coating layer was at least maintained, or even improved.

### Example of Coating of Polyethylene Web

The composition n°6 of Table 4 was applied on a face of a polyethylene web of 200 g/m². After hardening of the composition, a flexible film layer was obtained.

### Example of Pouring Sample

The composition n°8 of Table 4 was poured so as to produce samples for being tested according to the standards BS EN ISO 1716 and ASTMD2015. The maximum amount of heat that the sample can release under highly idealized conditions was determined in an oxygen bomb calorimeter using adiabatic and isothermal methods. This test determines the maximum total heat release of the material after complete combustion, i.e. the difference between the gross heat of combustion and the residual heat after 2 hours of combustion. A gross heat of combustion of about 85 KJ/Kg was determined, meaning that the product is considered as an extremely non combustible materials (M0). The presence of the adhesive resin had no impact on gross heat of combustion, nor on its classification (M0).

Mechanical tests were also performed on the sample according to the NBN EN 196-1 standards. It was determined that the product had the following properties modulus of rupture higher than about 15.5 Mpa, compressive strength higher than about 30-40 Mpa, young's modulus higher than about 2200-4500 Mpa.

The water capillary porosity was less than 10% (ASTM C948-81).

### Examples of Coating Compositions Suitable for Being Sprayed on a Support in a

Very Thin Uniform Layer (Less than 1 mm, Especially Less than 500 μm, such as 250 μm, 100 μm or Even Less)

TABLE 6
Liquid Coating compositions

| Composition | | | | | | | |
|---|---|---|---|---|---|---|---|
| 1 | 2 | 3 | 4 | 5 | 6 | 7 | 8 |

binder

| | | | | | | | | |
|---|---|---|---|---|---|---|---|---|
| SiO₂ (g) | 20 | 25 | 30 | 30 | 40 | 25 | 30 | 35 |
| Al₂O₃ (g) | 30 | 25 | 20 | 20 | 20 | 35 | 30 | 25 |
| PA (g) | 150 | 150 | 150 | 150 | 150 | 150 | 140 | 150 |
| Molar ratio | 0.58 | 0.73 | 0.87 | 0.87 | 1.16 | 0.73 | 0.93 | 1.02 |
| SiO₂/P₂O₅ of | | | | | | | | |
| the binder | | | | | | | | |
| AEP (g) | 1 | 0.5 | | 0.5 | | 0.25 | | |
| SBR (g) | | | 0.75 | 0.5 | | 0.25 | 0.25 | |
| PAE (g) | | | | | 0.25 | | 0.25 | 1 |
| pH | 0.5 | 0.5 | 0.5 | 0.5 | 0.5 | 0.5 | 0.5 | 0.5 |

Added water/calcium silicate and possible fillers

| | | | | | | | | |
|---|---|---|---|---|---|---|---|---|
| Water (g) | 100 | 100 | 100 | 100 | 100 | 100 | 100 | 100 |
| CS1 (g) | 100 | 100 | 75 | 100 | 50 | | 50 | 100 |
| CS2 (g) | | | | | | 50 | 50 | |
| CS3 (g) | | | | | 50 | 50 | | |
| CS4 (g) | | | | | | | | |
| GF1 (g) | | | | | | | | |
| GF2 (g) | | | | | | | | |
| Sf (g) | | | | | | | | |

Characteristic of the composition

| pH | <1 | <1 | <1 | <1 | <1 | <1 | <1 | <1 |
|---|---|---|---|---|---|---|---|---|
| | Composition | | | | | | | |
| | 9 | 10 | 11 | 12 | 13 | 14 | 15 | 16 |

binder

| | | | | | | | | |
|---|---|---|---|---|---|---|---|---|
| SiO₂ (g) | 20 | 25 | 30 | 30 | 40 | 25 | 30 | 35 |
| Al₂O₃ (g) | 30 | 25 | 20 | 20 | 20 | 35 | 30 | 25 |
| PA (g) | 150 | 150 | 150 | 150 | 150 | 150 | 140 | 150 |
| AEP (g) | 0.2 | | | 0.6 | | | 0.3 | 0.2 |
| SBR (g) | | 0.1 | 0.4 | | 0.6 | | 0.1 | |
| PAE (g) | | 0.3 | | | | 0.6 | | 0.2 |
| Molar ratio | 0.58 | 0.73 | 0.87 | 0.87 | 1.16 | 0.73 | 0.93 | 1.02 |
| SiO₂/P₂O₅ of | | | | | | | | |
| the binder | | | | | | | | |
| pH | 0.5 | 0.5 | 0.5 | 0.5 | 0.5 | 0.5 | 0.5 | 0.5 |

Added water/calcium silicate and possible fillers

| | | | | | | | | |
|---|---|---|---|---|---|---|---|---|
| Water (g) | 100 | 100 | 100 | 100 | 100 | 100 | 100 | 100 |
| CS1 (g) | | 50 | 40 | 60 | 25 | | 25 | 75 |
| CS2 (g) | | | | | | 25 | 25 | |
| CS3 (g) | 25 | | | | 50 | 25 | | |
| CS4 (g) | 25 | | | | | | | |
| GF1 (g) | 50 | | 30 | | | 40 | 35 | 25 |
| GF2 (g) | | 20 | | 40 | | | | |
| Sf (g) | | 30 | 10 | | | 10 | 15 | |

Characteristic of the composition

| | | | | | | | | |
|---|---|---|---|---|---|---|---|---|
| pH | <1 | <1 | <1 | <1 | <1 | <1 | <1 | <1 |

In said table 6, the meaning of the abbreviations are:
The liquid reactive composition was prepared by using the following products:
WATER W: demineralized water with a very low calcium/magnesium content (less than 20 ppm)
SiO₂: precipitated SiO₂ particles with an average particle size of about 10 μm, said particles having a purity of 99% by weight
Al₂O₃: powder with an average particle size of about 10 μm and a purity of 99% by weight
Phosphoric acid PA: concentrated phosphoric acid, as an aqueous solution containing 75% by weight phosphoric acid
Calcium silicate CS1: calcium meta silicate powder, water insoluble, acicular nature with a length/breadth or aspect ratio of about 3 to 5, advantageously about 3, with an average weight particle of about 15 μm. The calcium silicate comprises more than about 46% (weight) CaO and more than about 51.5% (weight) (calculated after burning).
Calcium silicate CS2: calcium meta silicate powder, water insoluble, acicular nature with a length/breadth or aspect ratio of about 3 to 5, advantageously about 3, with an average weight particle of about 10 μm. The calcium silicate comprises more than about 46% (weight) CaO and more than about 51.5% (weight) (calculated after burning).
Calcium silicate CS3: calcium meta silicate powder, water insoluble, acicular nature with a length/breadth or aspect ratio of about 3 to 5, advantageously about 3, with an average weight particle of about 5 μm. The calcium silicate comprises more than about 46% (weight) CaO and more than about 51.5% (weight) (calculated after burning).
Calcium silicate CS4: calcium meta silicate powder, water insoluble, acicular nature with a length/breadth or aspect ratio of about 3 to 5, advantageously about 3, with an average weight particle of about 2.5 μm. The calcium silicate comprises more than about 46% (weight) CaO and more than about 51.5% (weight) (calculated after burning).
Glass fibre (GF1): glass fibre with a length of about 50 μm, said fibre being treated with a water repellent silane layer (fluoro silane layer)
Glass fibre (GF2): glass fibre with a length of about 25 μm, said fibre being treated with a water repellent silane layer (fluoro silane layer)
Silica fume (Sf): average particle size (in weight) below 1 μm.
AEP: adhesive resin as disclosed in the description of the binders of table 1
SBR: styrene-butadiene rubber latex as disclosed in the description of the binders of table 1
PAE: polyacrylic emulsion as disclosed in the description of the binders of table 1
The content in AEP, SBR and PAE is given in dry solid content or matter, i.e. after removing all the free water.

The liquid compositions were prepared as follows:

The compositions have been prepared by adding SiO2 particles to phosphoric acid. After dissolution of the SiO2 particles, Al2O3 particles were added. An acid alumina silica phosphate aqueous solution was so achieved. The pH of said acid solution, measured at 20° C. was less than about 0.5.

Water was first mixed with the adhesive resin or the mixture of adhesive resins, and then added to the solution, while keeping the pH of the solution below 1. If necessary some phosphoric acid can be added so as to maintain the pH below 1.

Calcium silicate particles was then added. The pH of the composition suitable to be sprayed was below 1.

Advantageously to said composition, some “inert” fillers were added, namely glass fibres and/or silica flume.

Water and/or phosphoric acid can be further be added, but the pH is preferably maintained below 1. It has been observed that when keeping the pH below 1, the fluidity of the composition can be ensured even if the composition has a solid content of about 30% by weight, whereby ensuring an efficient spraying of the composition with normal industrial spraying system.

It was also observed that the mixing of the suspension was more easy at such a low pH, and that the composition could be easily kept sufficiently homogeneous, even without mixing or shaking for a time sufficient for the spraying.

The liquid composition had a very good adhesion on various support, whereby enabling a very good and easy coating, such as with a spray system, but even with a brushing system or even a wiping system.

The compositions 1 to 16 were sprayed on a foamed support (PUR) in several spraying steps for achieving different coating layers, namely coating layers having different thickness, namely 2 mm, 1 mm, 750 μm, 500 μm and 250 μm. The variation of thickness was very low, namely a variation of less than 2% with respect to the average thickness. The fibres were well distributed, due to the easiness to keep the suspension homogeneous and due to the possibility to apply the suspension by spraying. For the layer having substantially a constant thickness, the variation of fibre content per cm² is less than 3% of the average (weight) fibre content determined for a coating surface of 1000 cm². It was even observed that it was possible to have fibres directed in substantially all the planar directions, whereby ensuring good mechanical properties for the coating as such in any planar direction.

After the spaying of the composition, the support provided with a wet coating was placed in a oven at 50° C. for 1 minute. After said drying, the coating was hardened and well attached to the support.

The coating has properties which are quite constant and uniform.

### Preparation of Foamed Products

For the preparation of said foamed fabric, the liquid compositions of Table 6 have been used.

In said compositions, an organic foamable composition, namely a foamable polyurethane, was added and mixed.

The Polyurethane can be added in the compositions when foaming or before its foaming. It seems that the Polyurethane foaming reaction was acting as a catalyst for the inorganic binder formation, while the inorganic binder formation was a catalyst for the polyurethane foaming reaction. It means that if required less catalyst can be used for the preparation of foamed polyurethane.

The weight ratio polyurethane foamable composition as dry matter/liquid composition of Table 6 as dry matter (i.e. after curing and drying) was 0.1, 0.2, 0.25, 0.3, 0.4 and 0.5.

The so obtained foamed product comprised a polyurethane foam structure in which an inorganic structure was homogeneously dispersed, said inorganic structure forming a net (substantially continuous) extending in all the volume of the polyurethane foam.

Various polyurethane foam compositions can be used.

The molecular structure, amount, and reaction temperature of each ingredient of the polyurethane determine the characteristics and subsequent use of the foam. Therefore, each formulation can be designed with the proper ingredients to achieve the desired properties of the final material. For instance, a switch in blowing agent can require an increase in this additive to maintain thermal properties. Increasing the amount of blowing agent can require more water or enables the use of large quantity of reacting liquid inorganic binder and/or a switch in surfactants to maintain optimum bubble sizes and formation rates during foaming. The density of the foam is determined by the amount of blowing, as well as by the amount of organic binder mixed therein. The stiffness and hardness of polyurethane can also be tailored by changing the level of flexible polyol in the chemical formulation. By mixing different combinations of the starting materials, the rates of the reactions and overall rate of cure during processing can be controlled.

Most PU foams consist of the following chemicals: 50 parts by weight polyol, 40 parts by weight polyisocyanates, and 10 parts by weight water and other chemicals. The 10 parts by weight water can be simply replaced by for example 10 to 20 parts by weight of liquid compositions of table 6.

Polyisocyanates and polyols are liquid polymers that, when combined with water, produce an exothermic (heat generating) reaction forming the polyurethane. The two polyisocyanates most commonly used are diphenylethane diisocyanate (MDI) and toluene diisocyanate (TDI). Both are derived from readily available petrochemicals and are manufactured by well-established chemical processes. Though MDI is chemically more complex than TDI, this complexity allows its composition to be tailored for each specific application. MDI is generally used in rigid foams, whereas TDI is typically used for flexible foam applications. Blends of MDI and TDI are also used.

Polyols are active hydrogen monomers based on polyesters, polyethers, or hydrocarbon materials that contain at least two active hydrogen atoms. The type of polyol used will determine whether the foam produced is flexible or rigid. Since most polyols immediately react with isocyanates when added together, it is easy to combine the polymerization and shaping processes into one step. During the polymerization proccess, the polyol and polyisocyanate molecules link and interconnect together to form a three dimensional material.

A wide range of additives are also used. Catalysts (tin and amines) speed up the reaction, allowing large volume production runs. Blowing agents that form gas bubbles in the polymerizing mixture, are required to produce foam. The amount of blowing can be tailored by adjusting the level of water. Flexible foams are typically made using the carbon dioxide formed during the reaction of water with isocyanate. Rigid foams use hydrochlorofluorocarbons (HCFCs), hydrofluorocarbons (HfCs), and pentanes as the blowing agents.

Surfactants are used for controlling the size of bubbles and include silicones, polyethers, and similar materials. Other additives that may be used include cross-linking agents, chain-extending agents, fillers, flame retardants and coloring materials, depending on the application.

Formation of Resin Organic Layer with an Inorganic Inner Structure

Waterborne PU coating formulations are known.

Such formulations are for example a one-component system based on a water-reducible blocked polyisocyanate and a hydroxy-functional polyurethane dispersion. The reaction between the water-reducible blocked polyisocyanate and the hydroxy-functional polyurethane dispersion (R′—OH) occurs through the use of heat to unblock the isocyanate groups and allow the traditional polyurethane reaction to take place. When methyl ethyl ketoxime is used as the blocking agent, a minimum baking cycle of 140° C. for 30 minutes is required.

When adding reactive ingredient for preparing the inorganic binder of the invention, an exothermic reaction occurs, said exothermic reaction being able to unblock the isocyanate groups for allowing the traditional polyurethane reaction to take place.

Such a PU composition with reactive ingredient for making inorganic binder can be used for making coatings, thin coatings, etc.

The invention relates thus also to a Polyurethane layer comprising an inorganic binder characterized by calcium silicate sites which are connected the one with the other by alumina-silica phosphate bonds. Advantageously, the calcium silicate sites acts as cross-linking sites for the alumina-silica phosphate bonds with a weight ratio Al₂O₃/SiO₂ ranging from 0.3 :1 and 10 :1.

The polyurethane layer can be with or without adhesive organic resin for enhancing hydraulic cement adhesion.

1. An inorganic binder having calcium silicate sites which are connected the one with the other by alumina-silica phosphate bonds, the calcium silicate sites acting as cross-linking sites for the alumina-silica phosphate bonds with a weight ratio Al₂O₃/SiO₂ ranging from 0.3:1 and 10:1, whereby after its hardening and drying, the inorganic binder comprises from 0.01% to 2% by weight of an adhesive resin for enhancing hydraulic cement adhesion.

2. The binder of claim 1, in which the adhesive resin is substantially homogeneously dispersed into the binder.

3. The binder of claim 1, in which the inorganic binder comprises from 0.05% to 1% by weight of an adhesive resin for enhancing hydraulic cement adhesion.

4. The binder of claim 1, in which the adhesive resin for enhancing hydraulic cement adhesion is selected from the group consisting of acrylic latexes, rubber latexes, vinyl acetate copolymers, polyvinyl acetate polymers, polyvinyl acetate copolymers, and mixtures thereof.

5. The binder of claim 1, in which the binder comprises at least one surfactant, the weight ratio surfactant/adhesive resin for enhancing hydraulic cement adhesion being lower than 0.1.

6. The binder of claim 5, in which the surfactant is nonionic surfactant.

7. The binder of claim 1, in which the binder comprises at least one surfactant, the weight ratio surfactant/adhesive resin for enhancing hydraulic cement adhesion being comprised between 0.01 and 0.05.

8. The binder of claim 1, in which the calcium silicate sites act as cross-linking sites for the alumina-silica phosphate bonds with a weight ratio Al₂O₃/SiO₂ ranging from 0.6 :1 and 6 :1.

9. The binder of claim 1, in which substantially all alumina-silica sites are bound the one to the other by alumina-silica phosphate bonds.

10. The binder of claim 1, in which the weight ratio calcium silicate site/SiO₂ present in the alumina-silica phosphate bonds is greater than 1.

11. The binder of claim 1, in which the weight ratio calcium silicate site/SiO₂ present in the alumina-silica phosphate bonds is greater than 1.5.

12. The binder of claim 1, in which the calcium silicate sites are calcium meta silicate sites having a substantially acicular nature with a length/diameter ratio from 2/1 to 50/1.

13. (canceled)

14. (canceled)

15. The binder of claim 1, in which the calcium silicate sites are calcium meta silicate sites having a substantially acicular nature with a length/diameter ratio from 2/1 to 50/1, the calcium meta silicate sites having an average length from 50 μm to 5 mm.

16. The binder of anyone of the claims 1, in which the weight ratio calcium silicate sites/alumina-silica phosphate bonds is comprised between 0.1 and 1.1.

17. (canceled)

18. (canceled)

19. A composition comprising at least:
an inorganic binder having calcium silicate sites which are connected the one with the other by alumina-silica phosphate bonds, the calcium silicate sites acting as cross-linking sites for the alumina-silica phosphate bonds with a weight ratio Al₂O₃/SiO₂ ranging from 0.3 :1 and 10 :1, whereby after its hardening and drying the inorganic binder comprises from 0.01% to 2% by weight of an adhesive resin for enhancing hydraulic cement adhesion, and
a filler.

20. The composition of claim 19, in which the filler is a silicon containing filler.

21. (canceled)

22. The composition of claim 19, which comprises silicon containing fibers with a length of less than 1000 μm, the weight content of silicon containing fibers with a length of less than 1000 μm in the composition after its hardening and after removal of the possible free water being of at least 0.5%.

23. A composition comprising at least:
an inorganic binder having calcium silicate sites which are connected the one with the other by alumina-silica phosphate bonds, the calcium silicate sites acting as cross-linking sites for the alumina-silica phosphate bonds with a weight ratio Al₂O₃/SiO₂ ranging from 0.3 :1 and 10 :1, whereby after its hardening and drying, the inorganic binder comprises from 0.01% to 2% by weight of an adhesive resin for enhancing hydraulic cement adhesion, and
an organic foamed material.

24. (canceled)

25. The composition of claim 23, in which the foamed material comprises polyurethane.

26. (canceled)

27. The composition of claim 23, in which Oil dry basis, the weight ratio inorganic binder/organic foamed material is comprised between 0.05 and 1.

28. (canceled)

29. (canceled)

30. (canceled)

31. (canceled)

32. (canceled)

33. (canceled)

34. The composition of claim 23, which comprises silicon containing fibers with an average (in weight) length comprised between 25 μm and 300 μm.

35. A product comprising at least a hardened layer comprising an inorganic binder having calcium silicate sites which are connected the one with the other by alumina-silica phosphate bonds the calcium silicate sites acting as cross-linking sites for the alumina-silica phosphate bonds with a weight ratio Al₂O₃/SiO₂ ranging from 0.3:1 and 10 :1, whereby after its hardening and drying the inorganic binder comprises from 0.01% to 2% by weight of an adhesive resin for enhancing hydraulic cement adhesion.

36. The product of claim 35, which comprises a support element at least partly covered by said hardened layer.

37. (canceled)

38. (canceled)

39. (canceled)

40. (canceled)

41. (canceled)

42. (canceled)

43. (canceled)

44. (canceled)

45. (canceled)

46. (canceled)

47. A process for the preparation of an inorganic binder having calcium silicate sites which are connected the one with the other by alumina-silica phosphate bonds, the calcium silicate sites acting as cross-linking sites for the alumina-silica phosphate bonds with a weight ratio Al₂O₃/SiO₂ ranging from 0.3 :1 and 10:1, in which water insoluble calcium silicate particles are mixed (a) with an acid alumina-silica phosphate solution at a temperature lower than 50° C., said acid alumina-silica phosphate solution comprising solubilized SiO₂ and having a pH of less than 2, said alumina-silica phosphate solution having a weight ratio Al₂O₃/SiO₂ ranging from 0.3 :1 and 10 :1, and (b) with an adhesive resin for enhancing hydraulic cement adhesion, so as to form a reacting binding composition, whereby the amount of adhesive resin for enhancing hydraulic cement adhesion is adapted so that the binding reacting composition after drying comprises from 0.01% and 2% of weight as dry matter of an adhesive resin for enhancing hydraulic cement adhesion.

48. (canceled)

49. (canceled)

50. (canceled)

51. (canceled)

52. (canceled)

53. (canceled)

54. (canceled)

55. (canceled)

56. (canceled)

57. (canceled)

58. A process for preparing a composition of anyone of the claims 23 to 34, in which a reacting binding composition formed by mixing water insoluble calcium silicate particles with an acid alumina-silica phosphate solution at a temperature lower than 50° C., said acid alumina-silica phosphate solution comprising solubilized SiO₂ and having a pH of less than 2, said alumina-silica phosphate solution having a weight ratio Al₂O₃/SiO₂ ranging from 0.3 :1 and 10 :1, is mixed with a foamable organic composition and with an adhesive resin for enhancing hydraulic cement adhesion, the so obtained reacting mixture after drying comprising from 0.01% and 2% of weight as dry matter of an adhesive resin for enhancing hydraulic cement adhesion.

59. (canceled)

60. (canceled)

61. (canceled)

62. (canceled)

63. (canceled)

64. (canceled)

65. (canceled)

66. (canceled)
